(19) United States
(12) Patent Application Publication
(10) Pub. No.: US 2014/0033171 A1
(43) Pub. Date: Jan. 30, 2014

(54) CUSTOMIZABLE MULTISTATE PODS

(71) Applicants: Jon Lorenz, San Francisco, CA (US); Kim P. Pimmel, San Francisco, CA (US)

(72) Inventors: Jon Lorenz, San Francisco, CA (US); Kim P. Pimmel, San Francisco, CA (US)

(21) Appl. No.: 12/146,027

(22) Filed: Jun. 25, 2008

Related U.S. Application Data
(60) Provisional application No. 61/041,549, filed on Apr. 1, 2008.

(51) Int. Cl. G06F 9/44

(52) U.S. Cl. 717/121

(57) ABSTRACT

Apparatus, systems, and methods may operate to receive a configuration of a configurable software object, the configuration including size and position data for displaying the configurable software object in a display. Further actions include retrieving data for the configurable software object, the data retrieved by a client-side engine associated with the display. The data is displayed in the display using the configurable software object, where the configurable software object is configured using the configuration. Apparatus, systems, and methods may also receive a request for a configurable software object, the configurable software object including size and position data for use within a display. Then, retrieve the configurable software object and transmit the configurable software object to a client, the client adapted to display the configurable software object using the size and position data. Additional apparatus, systems, and methods are disclosed.

### RELATED PATENT DOCUMENTS

This patent application claims the benefit of priority under 35 U.S.C. §119(e) to U.S. Provisional Patent Application Ser. No. 61/041,549 filed on Apr. 1, 2008 and entitled “Customizable Multistate Pods for Social Network and/or File Storage”, the contents of which are incorporated herein by reference in their entirety.

### COPYRIGHT

A portion of the disclosure of this document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots that may be illustrated below and in the drawings that form a part of this document: Copyright© 2008, Adobe Systems Incorporated. All Rights Reserved.

### TECHNICAL FIELD

The present application relates generally to the technical field of algorithms and programming and, in one specific example the creation of customized web pages in a social network environment.

### BACKGROUND

In recent years, online social networking has flourished. In a typical social network community, online users participate to share interests and activities with one another. Users may, for example, post images, video, or music, which expresses an aspect of each user's personality, viewpoint, or interest. Other means of communicating these personal characteristics include various messaging interfaces (e.g., chat, instant messaging, email, voice chat, discussion groups, etc.). In some social network communities, users are able to post web logs (blogs), share files, post hyper links to other web sites of interest, create and share friend lists, or other favorites lists (e.g., favorite music, favorite bands, favorite games, etc.).

Users in a social network community participate in various ways. One of the basic modes of participation is by sharing information with other users. For example, users may create a profile and post information, join sub-groups of a particular interest or particular common characteristic (e.g., attended the same school, live in the same city or region, share the same religious understanding, etc.), or interact with other users via messaging, discussion boards, surveys or polls, ratings, recommendations, or the like.

### BRIEF DESCRIPTION OF DRAWINGS

Some embodiments are illustrated by way of example and not limitation in the figures of the accompanying drawings in which:

FIG. 1 is a schematic diagram illustrating a computer network system, according to an example embodiment, having a client-server architecture.

FIG. 2 is a data flow diagram illustrating a system, according to an example embodiment, used to provide configurable software objects.

FIG. 3 is a flow chart illustrating a method, according to an example embodiment, of configuring a user interface.

FIG. 4 is a flow chart illustrating a method, according to an example embodiment, of providing a configurable software object.

FIGS. 5-8 are diagrams illustrating a Graphical User Interface (GUI), according to example embodiments.

FIG. 9 is a block diagram of a computer system, according to an example embodiment, used to configure a user interface.

FIG. 10 is a block diagram of a computer system, according to an example embodiment, used to provide a configurable software object.

FIG. 11 is a block diagram of an example computer system, according to various embodiments.

### DETAILED DESCRIPTION

For the purposes of this specification, the term “software object” includes a discrete unit of software. A software object may be characterized using procedures that act on the data. The data may represent properties of the software object. Procedures that act on the data may be referred to as interfaces or operations. In some example embodiments, the data is held private to the software object such that the only way to modify the data is by using the available interfaces. Software objects may be referred to as “software modules,” “software plug-ins,” or “software pods,” in various embodiments.

In some example embodiments, a system and method are shown that allows users of social networking web pages to generate custom software objects to facilitate the presentation of content within the social networking web pages. These software objects, may be generated using technologies including Adobe FLASH®, Adobe FLEX®, Asynchronous JavaScript and extensible Markup Language (XML) (AJAX), Dynamic Hyper Text Transfer Language (DHTML), a Visual Component Library (VCL), Component Library for Cross Platform (CLX), Java Beans (JB), Enterprise Java Beans (EJB), Component Object Model (COM), a Distributed Component Object Model (DCOM)), or other suitable technology. In some example environments, an Integrated Development Environment (IDE) may be supplied to a user. A user may select, create, or modify one or more of these objects for use in a social networking web page. In some example embodiments, these objects may be executed or referenced using ActionScript, Visual Basic Script (VBScript), JavaScript, or some other suitable scripting language. In an example embodiment, a software object may be embedded or incorporated into another software object, such as in a parent-child relationship. In another example embodiment, two or more software objects may be packaged together to form an aggregated software object. An aggregated software object may be referred to as a “software object library” in an example embodiment.

For the purposes of this specification, the term “online application” includes software applications that are provided in a networked, online environment. The software applications may have a client-server architecture, a peer-to-peer architecture, a distributed architecture, or other architectures using network infrastructures. In a client-server architecture, one example includes a web browser acting as the client and a web server acting as the server. Additional servers may be included to assist the web server in fulfilling its role, such as database servers, file servers, and the like. Online applications can include variations, such as web-based applications, thin-client applications, proprietary applications, or hybrid applications. Although many examples described herein are discussed in terms of a web-based application, this specification is not limited to these types of applications, but instead may be implemented as any variation of an online application.

A “desktop software application” includes software applications that are provided to a user from a software application installed at the user's local machine (e.g., a client computer). Desktop software applications may include office-suite types applications, such as word processors, spreadsheet applications, databases, and presentation software. Desktop software applications may also include more specialized applications, such as a digital graphics editor (e.g., Adobe PHOTOSHOP®), a page descriptive format document editor (e.g., Adobe ACROBAT®), or an online content editor (e.g., Adobe FLASH®, Adobe DREAMWEAVER®, or Adobe COLDFUSION®).

Software applications may include online applications or desktop software applications, in various embodiments. In addition, some software applications may be implemented as a hybrid application—one that has elements similar to both online applications and desktop software applications.

For the purposes of this specification, the term “electronic document” includes any electronic media content. Examples of electronic documents include, but are not limited to, word processing files, image files, multimedia presentation files, audio recordings, video recordings, spreadsheet files, database files, rendered documents, and page descriptive formats. An electronic document may include any electronic content (e.g., digital data) that may be presented to a user (e.g., visually or audibly presented). Electronic content may include static content, such as text, pictures, drawing objects, tables, and the like. Electronic content may include dynamic content, such as a video recording, a movie, a documentary, a video sample clip, an animation, and other like electronic content. Electronic documents may include a mixture of static and dynamic electronic content.

A “content element” shall include any part or share of electronic content that is defined or discernable as a part or share. For example, a content element may be automatically discerned from a characteristic of the content element itself (e.g., a paragraph of an electronic document, or a file format designation), or may be manually defined by a user (e.g., a user-selected collection of words in an electronic document or a user-selected portion of a digital image). Other examples of content elements include portions of a page-descriptive document or other electronic document. Portions of a page-descriptive document may further include pieces of electronic text or other material within the electronic document, dynamic content in the form of portions of media streams such as sections of digital video or frames or sets of frames of digital video or digital audio, dynamic content in the form of segments or frames of animations, electronic forms, form templates, form elements, form data, actionable element specifications or executable instructions.

Content elements may include format data such as, for example, position information describing the placement of content elements, or information specifying colors or fonts to be used in rendering content elements.

For the purposes of this specification, a content item may be “associated” with electronic content. Examples of associated include inclusion within a file or other data structure containing the electronic content, the presence of a direct or indirect reference to the content element within electronic content, or the presence of a data structure, file, or other mechanism by which a content element is associated with electronic content. Content elements may be hidden from a user due to the location of a viewport, for example.

In considering the association between electronic content and an associated content element, the term “literally included” may be used. In this specification, electronic content may, for example, literally include a content element if the data structure that describes the electronic content includes data that largely describes the content element. A content element may be associated with electronic content by reference, wherein the data that describes the content element is not directly contained within or integral with the data that describes the electronic content with which the element is associated.

For the purposes of this specification, the term “rendering” used as a verb includes presenting or making accessible electronic content or content elements. Accessible includes to be perceived, viewed, or otherwise experienced by a user, or be made available for further processing, such as, for example, searching, digesting, printing, analyzing, distilling, or transforming by computational processes that may not include processing the intrinsic data structure describing the electronic content or content element. Whether a content element associated with electronic content is included in the rendering of the electronic content may, by default, be determined by whether or not the content element is active.

Rendering may include specialized processing that parses, compiles, executes or otherwise processes a standardized language formatted document. An example of such rendering is presenting a Hype Text Markup Language (HTML)—formatted document in an Internet browser. To present the document, the HTML formatting tags are parsed, code (e.g., scripts, event-driven actions, or pre-processing scripting) contained in the document interpreted, and then the resulting electronic content is displayed to a user.

For the purposes of this specification, the term “rendering” used as a noun includes human-perceivable representations of data that is within a machine and perception-specialized organizations of data defining such representations. For example, a rendering may include a pattern of human-perceivable matter or energy presented on an output device (e.g., a display) by a machine, as well as the organization of data within a machine that defines such patterns. For example, such organizations of data may include the electronic configuration of a memory used by a graphics display processor, or a file containing an audio segment suitable for playing via an audio system of a computer.

For the purposes of this specification, the term “rendering module” may be taken to include systems, applications, and mechanisms for rendering or presenting electronic content to a user, including the presentation of content elements such as text, graphics, form element renderings and other electronic content elements. An example of a rendering module includes a web browser component (e.g., Microsoft INTERNET EXPLORER®) or other component to render electronic content, such as HTML pages. Another example of a rendering module includes the Adobe ACROBAT® electronic publishing program. Other examples of a rendering module include the Adobe FLASH® Player program, as well as the Microsoft SILVERLIGHT™, MOOLIGHT™ browser plug-in.

For the purposes of this specification, the term “rendering program” includes applications for rendering or presenting dynamic content to a user. An example of a rendering program is the Adobe FLASH® Player 9 runtime software application. In many embodiments, a rendering module interacts with a rendering program to render dynamic content.

Certain applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). Modules may include hardware circuitry, optical components, single or multi-processor circuits, memory circuits, software program modules and objects, firmware, and combinations thereof, as appropriate for particular implementations of various embodiments. The term “module” includes an identifiable portion of code, data, or computational object to achieve a particular function, operation, processing, or procedure.

### Introduction

As networking facilities become more powerful and network access becomes more ubiquitous, users continue to find and develop new forums to create and share content with one another. Web sites and other forums that users access to browse, share, and explore may be referred to as online communities or social networks. A participant in an online community or social network may become affiliated with tens or even hundreds of other users of the social network.

In general, as a participant of a social network, there are at least three main efforts. First, the participant may want to provide information about himself or herself. Second, the participant may want to track and maintain connections with friends, family, and other members of the online community. And third, the participant may want to create, share, or co-develop content, which may be authored by the participant or by others.

Software tools are described herein that assist a user to achieve these fundamental efforts. In particular, an integrated development environment is described where a user may create, remove, manage, and configure software objects in a user interface. The software objects may be thought of as views into the online community reflecting various aspects, such as the user's profile, the user's documents or other shared content, and the user's community.

In an example embodiment, a user is provided an integrated development environment to configure landing pages within a website. The landing pages include a home page, a community page, a profile page, and a document page. The primary mechanism used to configure these pages includes using one or more software objects to define “windows” or “frames” within the web page. Each window, or frame, may be designed with a particular use in mind, such as presenting a user's profile, presenting a user's community, or presenting a user's documents.

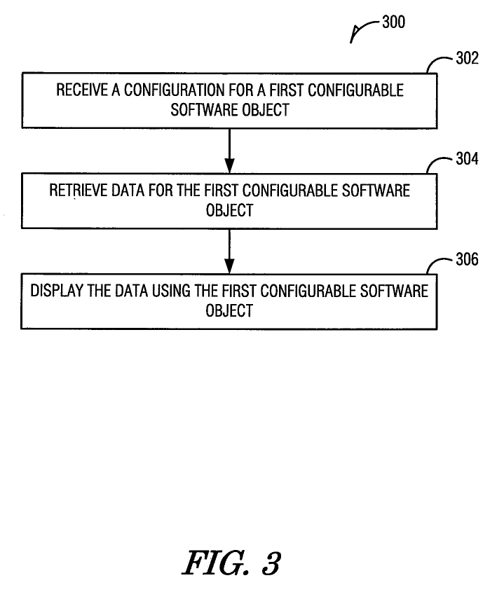

As an illustrative example, a user, who is a member of an online community, may click and drag a “community software pod” into a workspace. The workspace may represent the user's community landing page (e.g., the page used when the user navigates to their “Community Home Page”). The user may configure the community software pod to display family members who are in the online community. The user may click and drag another community software pod into the workspace, arranging the pod to their preference with respect to the previously selected community software pod, and then configure the new community software pod to display friends who are in the online community. The community members presented in the “family” community pod may be mutually exclusive from the members presented in the “friends” community pod, or there may be some overlap, depending on the user's classification of the people in the pods. Other example pods and their example configurations are described below, with respect to FIGS. 3-6.

### System Overview

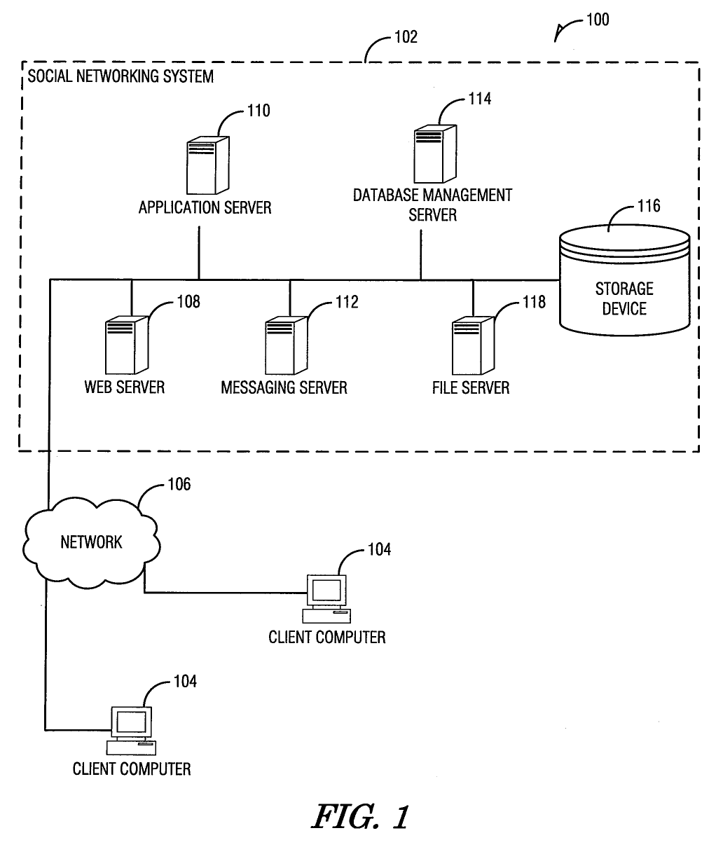

FIG. 1 is a schematic diagram illustrating a computer network system 100, according to an example embodiment, having a client-server architecture. The computer network system 100 includes a social networking system 102 and one or more client computers 104, communicatively coupled via a network 106. In an embodiment, the social networking system 102 includes a web server 108, an application server 110, a messaging server 112, a database management server 114, which is used to manage at least a storage device 116, and a file server 118. The social networking system 102 may be implemented as a distributed system. For example, one or more elements of the social networking system 102 may be located across a Wide-Area Network (WAN) from other elements of the social networking system 102. As another example, a server (e.g., web server 108, file server 118, database management server 114) may represent a group of two or more servers, cooperating with each other, in providing a pooled, distributed, or redundant computing model.

The client computers 104 may include an electronic device in various forms, such as a mobile communication device (e.g., a PDA, a cellular phone, a smart phone, etc.), a laptop computer, a desktop computer, a dedicated client computing device (e.g., a kiosk), or other devices capable of network communication and visual presentation. In addition, the client computers 104 may include a thin-client, a thick-client, a fat client, a hybrid client, or other client model typically found in a client-server architecture.

The network 106 may include Local-Area Networks (LAN), WAN, wireless networks (e.g., 802.11 or cellular network), the Public Switched Telephone Network (PSTN) network, ad hoc networks, personal area networks (e.g., Bluetooth® network) or other combinations or permutations of network protocols and network types. The network 106 may include a single LAN, WAN, or combinations of LANs or WANs, such as the Internet. The various devices coupled to the network 106 may be coupled to the network 106 via one or more wired or wireless connections.

The web server 108 may communicate with the file server 118 to publish or serve files stored on the file server 118. The web server 108 may also communicate or interface with the application server 110 to enable web-based presentation of information. For example, the application server 110 may provide scripts, applications, or library files that support primary or auxiliary functionality of the web server 108 (e.g., multimedia, file transfer, or dynamic interface functions). In addition, the application server 110 may provide some or the entire interface for the web server 108 to communicate with one or more other servers in the market performance analysis system 102 (e.g., the messaging server 112 or the database management server 114). The web server 108, either alone or in conjunction with one or more other computers in the market performance analysis system 102, may provide a user interface. The user interface may be implemented using a variety of programming languages or programming methods, such as HTML, VBScript, JAVASCRIPT™, XML, XSLT™ (Extensible Stylesheet Language Transformations), AJAX, JAVA™, JFC (JAVA™ Foundation Classes), and Swing (an Application Programming Interface for JAVA™).

In an embodiment, the client computer 104 may include a client program (e.g., a rendering program or rendering module) to interface with the social networking system 102. The client program may include commercial software, custom software, open source software, freeware, shareware, or other types of software packages. In an embodiment, the client program includes a thin client designed to provide query and data manipulation tools for a user of the client computer 104. The client program may interact with a server program hosted by, for example, the web server 108 or the application server 110. Alternatively, the client program may interface with the database management server 114.

In addition, the client computer 104 may include one or more “helper applications.” A “helper application” includes software applications that work in conjunction with another application that may be considered a parent application to the helper application. For example, an Internet browser application may include one or more helper applications (e.g., plug-in applications or Browser Helper Objects) that enable a user to view a certain type of content. One example of a helper application in this context includes Adobe ACROBAT® READER® that allows a parent application (such as an Internet browser application) to view Adobe ACROBAT® formatted documents.

The storage device 116 may include a database, a memory, a disk, or similar devices. In an embodiment, the storage device 116 may comprise one or more logical or physical databases. For example, the storage device 116 may be viewed as a system of databases that when viewed as a compilation, represent a “storage device.” Sub-databases in such a configuration may include a document database, a user database, a document history database, an operations database, and the like. The storage device 116 may include a database implemented as a relational database, a centralized database, a distributed database, an object oriented database, or a flat database in various embodiments.

Some embodiments may include the various databases (e.g., storage device 116) being relational databases, flat files, XML based databases, object databases, or, in some cases, Online Analytic Processing (OLAP) based databases. In the case of relational databases, various tables of data are created and data is inserted into and/or selected from these tables using SQL or some other database-query language known in the art. In the case of OLAP databases, one or more multi-dimensional cubes or hyper cubes, including multidimensional data from which data is selected from or inserted into using a Multidimensional Expression (MDX) language, may be implemented. In the case of a database using tables and SQL, a database application (e.g., database products) such as, for example, MYSQL™, MICROSOFT SQL SERVER™, ORACLE 8I™, 10G™, or some other suitable database application may be used to manage the data. In this, the case of a database using cubes and MDX, a database using Multidimensional Online Analytic Processing (MOLAP), Relational Online Analytic Processing (ROLAP), Hybrid Online Analytic Processing (HOLAP), or some other suitable database application may be used to manage the data. The tables or cubes made up of tables, in the case of, for example, ROLAP, are organized into an RDS or Object Relational Data Schema (ORDS), as is known in the art. These schemas may be normalized using certain normalization algorithms so as to avoid abnormalities such as non-additive joins and other problems. Additionally, these normalization algorithms may include Boyce-Codd Normal Form or some other normalization or optimization algorithm known in the art.

During operation, a user (not shown) at a client computer 104 can access the social networking system 102 to perform various tasks. The user may configure their interface into the social networking system 102, in effect, configuring their own web portal. For example, the user may create customized views of their favorite or frequently-visited content. The content may represent profiles of other users, documents, links, pictures, music, online forums (e.g., a bulletin board, a messages area, a discussion board), interactive communication (e.g., web talk, instant messaging), or other information.

In addition, the user may access the social networking system 102 to create, upload, remove, or otherwise manage electronic documents stored at the social networking system 102. The electronic document may be stored, in whole or in part, at the client computer 104 where the user is working. Once uploaded or otherwise stored at the social networking system 102, the user may organize electronic documents using configurable software objects. For example, to organize documents by categories, a user may create a “Favorites” software pod, an “In progress” software pod, and an “Archive” software pod. These software pods may act like views into an electronic document repository, in one example embodiment. In another example embodiment, the software pods may act like folders in a file directory system.

When configured to act like views, software pods may use a database-like implementation. That is, each electronic document may be characterized with one or more attributes (e.g., size, file name, file type, category, author, creation date, last modified date, number of views, number of revisions, etc.). Using a query, a software pod can present electronic documents that match the criteria of the query. The query may be implemented with user interface controls (e.g., labeled checkboxes to indicate required fields). The query may also be implemented using a more conventional mechanism, such as a text-based Boolean query.

When configured to act like folders, software pods may be linked to a physical directory in a file system, in an example embodiment. In such an embodiment, the software pod merely reflects the contents, which may be filtered, of the underlying file system directory. The user may manage the files using either the pods, or other mechanisms, such as File Transfer Protocol (FTP), web folders, remote access, or other directory management tools. In another example embodiment, software pods are implemented similar to a query-based implementation, but with the additional limitation that each electronic document may only exist in a single software pod, thus creating a directory-like system.

In an example embodiment, one software pod may be contained in another software pod. For example, a directory-like software pod may contain sub-directory software pods. A user may then navigate through the pod directory in a similar manner as other GUIs. As another example, a query-based software pod may retrieve other software pods in the query result and present the software pods to a user.

While the system 100 shown in FIG. 1 employs a client-server architecture, the present invention is of course not limited to such an architecture, and could equally well find application in a distributed, or peer-to-peer, architecture system, for example. Additionally, while various computers and storage devices are illustrated as separate components in FIG. 1, it is understood that functionality of these components may be merged, distributed, or otherwise organized into different configurations, depending on the implementations due to design preferences, cost restrictions, geographical limitations, or other business, technical, or practical considerations. Thus, the following paragraphs present only some of many potential embodiments that can be used in this respect.

### System for Configuring a User Interface

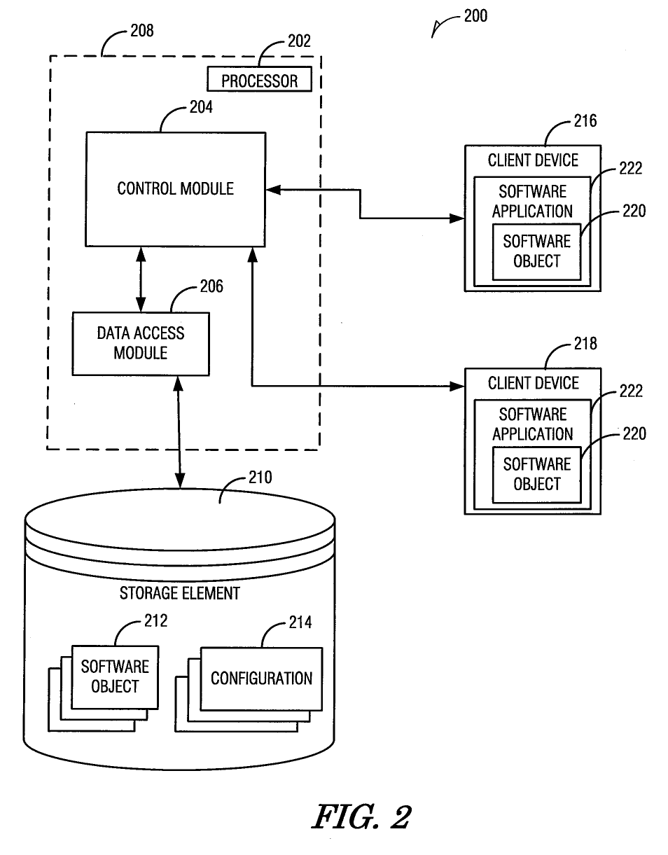

FIG. 2 is a data flow diagram illustrating a system 200, according to an example embodiment, used to provide configurable software objects. The system 200 may include a number of modules such as one or more processors 202, a control module 204, and a data access module 206. These modules (202, 204, and 206) may be associated within a machine 208, as indicated by their containment within the dashed box. Those of ordinary skill in the art will understand that any of the modules (202, 204, or 206) shown to be located within the confines of the machine 208 may also be located outside the machine 208, and appropriately coupled to the machine 208 via a physical or logical connection.

The control module 204 may be used to manage access requests, write operations, and other operations related to software objects or configurations stored at the system 200 or at auxiliary systems. The system 200 may include a web server, a database server, a transaction server, a business rules system, a customer relation management system, or combinations thereof. In general, the control module 204 allows users to store software objects or configurations at the system 200.

The data access module 206 may be used by the control module 204 to access a storage element 210. The storage element 210 may comprise memory devices such as a database, a memory, a disk, or other storage device.

The storage element 210 may serve to store one or more software objects 212. The data access module 206 may operate to read and/or write the software objects and may provide reading and writing services for the benefit of other system modules, including the control module 204 and the processor 202. In addition, the storage element 210 may serve to store one or more configurations 214, where each configuration 214 is associated with one or more software objects 212 stored in the storage element 210.

The control module 204 may be operably coupled to client devices 216 and 218. The client devices 216 and 218 may comprise devices, such as a computer, a display screen, a handheld portable device, a kiosk, or other client devices used to present or display an electronic document. The client devices 216, 218 may be used to present a software object 220, for example, by using a software application 222. The software object 220 may be configured using one or more configurations 214.

In an example embodiment, a user may operate a client device 216 to access and load a software object 220, retrieved from the storage element 210 via the machine 208. The user may have previously configured the software object, in which case the associated configuration 214 is retrieved from the storage element 210 via the machine 208 and used to configure the local copy of the software object 220. If the user had not previously configured the software object 220, in an example embodiment, a default configuration is used. The default configuration may be retrieved from the storage element 210, in an example embodiment. In another example embodiment, a default configuration is included in the software object 220 or in the software application 222. The user may alter the configuration of the software object 220, after which the configuration may be stored at the storage element 210 for later reference. For example, the user may access the software object 220 from another client 218, at which time the software application 222 configures the software object 220 using the previously saved configuration 214. In an example embodiment, the configuration 214 may include configurations for a plurality of software objects. For example, the configuration 214 may be associated with a user and stored at a single location. Additionally, the software object 212 used by the user may also be stored in a single location.

### Methods for Configuring a User Interface to a Social Network Community

FIG. 3 is a flow chart illustrating a method 300, according to an example embodiment, of configuring a user interface. At 302, a first configuration for a first configurable software object is received. The first configuration may include size and position data for displaying the first configurable software object in a display. At 304, first data for the first configurable software object is retrieved. The first data may be retrieved by a client-side engine associated with the display. Examples of client-side engines include, but are not limited to, Adobe FLASH®, Adobe FLEX®, AJAX, SILVERLIGHT™, MOONLIGHT™, or other suitable technology. At 306, the first data is displayed in the display using the first configurable software object, where the first configurable software object is configured to display the data using the first configuration. In an example embodiment, a software platform is used to provide the implementation of the software objects. For example, a FLASH® application may use one or more ActionScript objects to provide configurable software objects.

In a further example embodiment, a second configuration of a second configurable software object is received. The second configurable software object may be configured to interact with the first configurable software object. The second configuration may include size and position data for displaying the second configurable software object in the display. In such an embodiment, second data for the second configurable software object is retrieved. The second data may be retrieved by the client-side engine associated with the display. Finally, the second data is displayed in the display using the second configurable software object. The second data displayed based on the interaction with the first configurable software object. In addition, the second configurable software object is configured to display the second data using the second configuration. In an example embodiment, the first configurable software object is displayed as a first sub-display within the display, and the second configurable software object is displayed as a second sub-display within the display.

In a further example embodiment, the configuration is stored at a social networking system. For example, referring to FIG. 1, the configuration may be stored in the storage device 116, a file server 118, a web server 108, an application server 110, or across several servers or devices.

In a further example embodiment, a software object library is accessed to retrieve the first configurable software object. The software object library may be publicly accessible, as a shareware, freeware, or commercial repository of software objects. The software library may also be privately maintained, such that a subscription, pay-for-access, or other licensing or commercial schemes are used to limit the access to software objects.

In a further example embodiment, an electronic document is accessed using the first configured software object; and displaying the electronic document using the first configurable software object. For example, the configurable software object may act as a document container to display one or more available documents. The documents may be a subset of documents available to a user, for example, documents related to a particular genre, author, subject matter, publication date, or the like.

In an example embodiment, the first configuration is user-defined. In the alternative, configurations may be provided by a social network service provider or other third parties, such as in a commercial endeavor.

In a further example embodiment, the first configuration is received by first accessing a remote database managed by a social networking system and then retrieving a user-defined configuration.

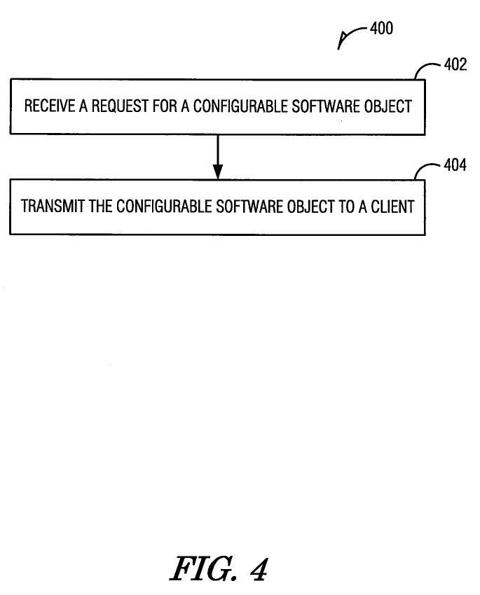

FIG. 4 is a flow chart illustrating a method 400, according to an example embodiment, of providing a configurable software object. At 402, a request for a configurable software object is received. The configurable software object may include size and position data for use in a display. The display may comprise a graphical user interface in an example embodiment. At 404, the configurable software object is transmitted to a client. The client may be adapted to display the configurable software object using the using size and position data.

In a further embodiment, it is determined whether the configurable software object has an associated user-defined configuration and, if so, then the user-defined configuration is accessed. The user-defined configuration may be stored at a social networking server, for example. As another example, the user-defined configuration may be stored at a client machine. In an example embodiment, a database associated with a social networking system is queried to obtain the user-defined configuration. In a further example embodiment, a software object library is accessed to retrieve the requested configurable software object.

In an example embodiment, the request includes viewport dimensions of a display device to be used to present the configurable software object; and further comprising revising the configuration associated with the configurable software object to conform to the viewport dimensions. Viewport dimensions may be provided using pixel values, for example, 1280×1024 pixels.

Some example embodiments may include the above-illustrated operations being written as one or more software components. These components, and the functionality associated with each, may be used by client, server, or peer computer systems. These various components can be implemented into the system on an as-needed basis. These components may be written in an object-oriented computer language such that a component oriented or object-oriented programming technique can be implemented. These components are linked to other components via various Application Programming Interfaces (APIs) and then compiled into one complete server and/or client application. The method for using components in the building of client and server applications is well known in the art. Further, these components may be linked together via various distributed programming protocols as distributed computing components.

### Example Implementations

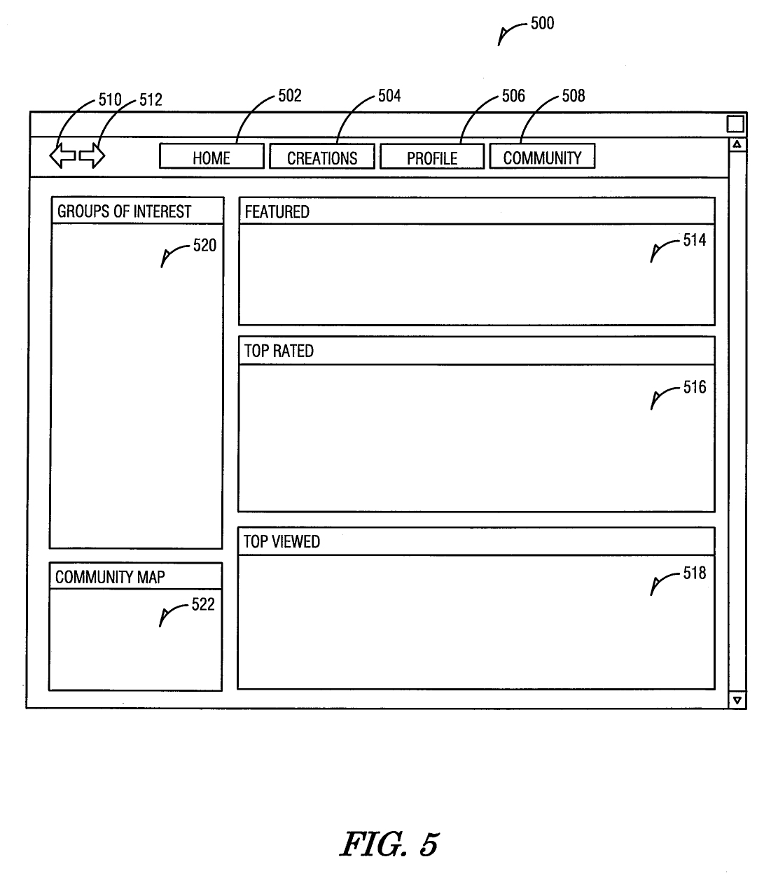

FIG. 5 is a diagram illustrating a GUI 500, according to an example embodiment. In the embodiment illustrated, the GUI 500 includes a navigation area at the top of the window. The navigation area includes a home control 502, a creations control 504, a profile control 506, and a community control 508. The controls 502, 504, 506, and 508 may be used to quickly navigate to the named destination. The navigation area also includes a back control 510 and a forward control 512 to navigate to previously viewed interfaces. Although not illustrated in FIG. 5, it is understood that other window and navigation controls may be included in the interface 500, such as search controls, window controls (e.g., to expand, collapse, or close a window or pod frame), or other navigation menus, links, or controls.

Each control 502, 504, 506, and 508 may be used to navigate to a particular presentation, which may be implemented as a web page. For the purposes of this discussion, there are four distinct presentations, a Home page, a Creations page, a Profile page, and a Community page. Each presentation page will be described briefly.

The home control 502 may be used to navigate to a Home page. The Home page is the default landing interface for the user. Using methods and systems described herein, the user may configure the arrangement, content, and other aspects of the Home page via the use of configurable software objects.

The creations control 504 may be used to navigate to a Creations page. In an example embodiment, the Creations page is used to organize, store, and manage content, such as electronic documents. Content may be user-generated, either individually or collaboratively. Content may also be generated by a third party, such as a commercial producer (e.g., a television network, a file production company, a professional artist, or an internet service provider). Software objects designed to organize, display, share, or otherwise manage content may be used on the Creations page to provide a customized interface for the user.

The profile control 506 may be used to navigate to a Profile page. The Profile page, in an example embodiment, is used to control what information is displayed to other users of a social network system (e.g., item 102 in FIG. 1), or how the information is presented. In general, a Profile page may be used to manage the content presented to other users of the system when they view the user's profile.

The community control 508 may be used to navigate to a Community page. The Community page may be used to organize information about one or more communities that the user is interested in or a member of. In general, the Community page may be used to display community-oriented information to the user.

FIG. 5 also includes several frames or sub-windows, each corresponding to an interface of a software pod. Each pod may be used to display information as defined by the type of pod used. Pods may be generic (e.g., configured to display information from any source) or proprietary (e.g., configured to display information from the pod provider). Pods may be implemented as transportable software objects. For example, a user may develop a pod to display particular subject matter, such as favorite quotes from a public data source. The user may then publish the pod as a transportable software object for other users to download and use on their home page. In addition, for example, the user may publish the code used to implement the favorite quote pod so that other users may adapt or improve the code and re-publish a revised pod.

In addition, in some embodiments, a user may save the configuration of several pods, such as those shown arranged in the graphical user interface 500 in FIG. 5. The user may then be able to recall the saved configuration. For example, the user may save several versions of configurations and then switch, toggle, swap, or navigate between the saved versions of configurations. As an example, the user may save a version of the Community landing page oriented toward business contacts, and then save another version of the Community landing page oriented toward social contacts. The user may then navigate from one version to another to view the information of interest at a particular time. The user may also be able to export the saved configuration, which may be used as an offline backup, for example, or as a method of sharing the configuration with other users, as another example.

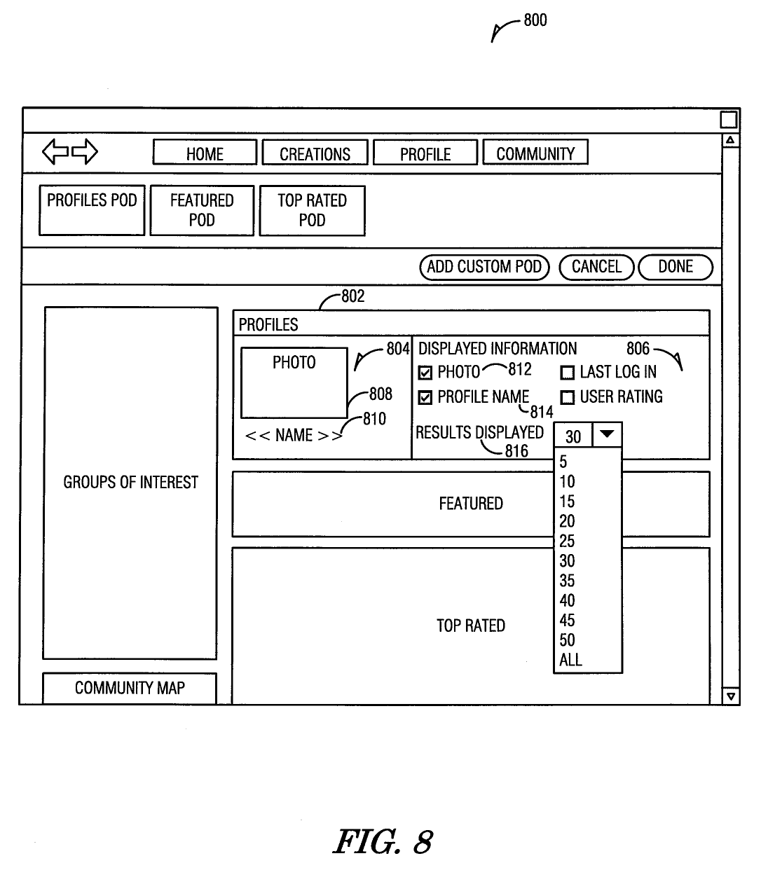

In the example shown in FIG. 5, the featured pod 514 includes content that is featured by the service provider (e.g., a social networking service provider). Content may include documents, videos, pictures, friends, communities (e.g., groups), music, etc. The featured pod may be configurable, for example, to display a particular number of featured items, to change the order of the featured items, to filter the featured items, or other changes. The configuration is discussed in more detail with respect to FIG. 8 below.

The top rated pod 516 includes highly rated items. For example, videos hosted by an external site may include ratings that reflect the popularity, quality, or other quantifiable aspect of the content. The ratings may be based on user ratings. Using these ratings, the top rated pod 516 may display a configured presentation, e.g., the top ten or top twenty videos in a particular category. As with the featured pod, the top rated pod may be configurable, for example, by filtering the type of content based on keyword, category, source, maturity ratings, content type, content length, content format, or the like.

The top viewed pod 518 includes frequently viewed content items. For example, content made available in the featured pod 514 may be tracked by the content provider to obtain the number of times each content article is viewed or accessed. The top viewed pod 518 can be used to display a subset of the content from the featured pod 514, for example. The top viewed pod 518 may also be configured to display other content that is frequently viewed, such as the user's own creations that are viewed or accessed by other users. As with the other pods described, the top viewed pod 518 may be configurable, for example, by limiting the number of content items shown, filtering content items based on a minimum number of views, filtering content items based on the content or author, or the like.

The groups of interest pod 520 may be implemented to display groups that the user belongs to or is otherwise associated with. Again, the groups of interest pod 520 may be configurable, for example, by ordering the groups displayed (e.g., by the number of members, in alphabetical order, or by activity), filtering the groups based on subject matter interest, or the like.

The community map pod 522 may include one or more representative geographical maps with indicia that indicate the physical location of social network members. The community map pod 522 may be configured to display various geographical resolutions (e.g., a country, a state, a city). The community map pod 522 may be further configurable to display different sets of people with which the user is associated with. For example, the community map pod 522 may be configured to display a map of the United States along with a graphical indication (e.g., a pin icon, a star, a dot) to indicate the location of each family member (who is also a member of the social networking system). User interface controls (not shown) may be used to modify the view to display other countries or various resolutions of geographic areas. Other user interface controls may be used to change the members being shown on the map changing from a view of family members to a view of members of a group of interest that the user belongs to. The map displayed in the community map pod may be configurable in several ways, such as by specifying a default view (e.g., a default country or state), showing or hiding zoom or other navigation controls, enabling or disabling zoom or other navigation controls, colors used for specific friends or types of friends, etc.

In various embodiments, the pods 514, 516, 518, 520, and 522 may be configured by a viewing user. For example, a viewing user may arrange the pods (e.g., resizing or changing the pod's position). As another example, a viewing user may change the display configuration (e.g., changing the number of top rated content items shown). Additional configurable aspects may include showing or hiding various characteristics of the content items (e.g., the title, author, length, size, source, comments, etc.). This is discussed further at FIG. 8.

While not shown in these figures, it is considered to be within the scope of this description to have an interface with multiple instances of a particular pod. For example, a user may configure one top rated pod 516 to display top rated movies and another top rated pod 516 to display top rated books. Having both pods viewable at the same time may be a desired configuration.

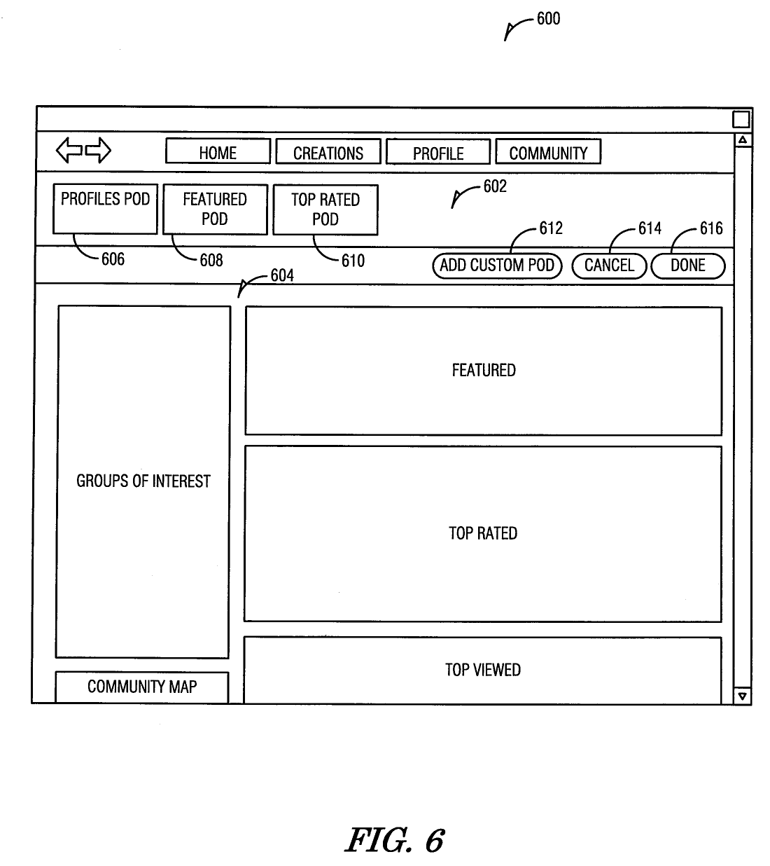

Using a user interface command, such as via a menu, the author may change the user interface from a presentation mode to an edit mode. While some of the pods' characteristics may be configured in presentation mode, the edit mode allows the author to change more fundamental aspects of the user interface, such as which pods are displayed. FIG. 5 illustrates the use of software objects (pods) in a presentation mode. FIG. 6 illustrates the use of software objects in an edit mode.

FIG. 6 is a diagram illustrating a GUI 600, according to example embodiments. In the embodiment illustrated in FIG. 6, the GUI 600 has been changed to an edit mode. In edit mode, the GUI is separated into two areas: a pod toolbar 602 and a staging area 604. The pod toolbar 602 is used to display the available pods for use in the staging area 604. In the example illustrated in FIG. 6, the pod toolbar 602 includes a profiles pod template 606, a featured pod template 608, and a top rated pod template 610. It is understood that additional templates may be available in the pod toolbar 602.

To use the pod templates 606, 608, and 610, a user can click and drag a pod template 606, 608, and 610 from the pod toolbar 602 to the staging area 604. Pods that were already in the staging area 604 may be moved or deleted. Other functions may be available in the edit mode, such as copy and paste, importing custom pods, and importing or exporting an interface configuration. In an embodiment, the user may export the configuration. The configuration may be exported using a standardized interface language (e.g., XML). After exporting the configuration, the user may share the configuration with other users. Users may also be able to share portions of a configuration, e.g., just the configuration of a single pod or a subset of pods.

Pods may be developed by various parties, such as a user, a content provider, a third party, a commercial developer, or other software developers or producers. Pods developed by the social network service provider may be available by default with other pods, which were developed by the user or other external parties, may be imported into the social network system for use in a user's interface design. To provide integration with the native pods, user-developed or third party pods may be able to access data from the social network provider's system, such as, for example through the use of an API made available from the provider. Either third party pods or application-provided pods may access external data for display in a pod.

FIG. 6 includes an add custom pod control 612, which the user may activate to add a custom pod to the pod toolbar 602. For example, after activating the add custom pod control 612, a list may be presented to the user to choose among various available custom pods. Alternatively, a open file dialog interface may be presented to the user so that the user can navigate to a location (e.g., at the user's local machine) to identify and upload a file representing a custom pod. As another example, the add custom pod may activate an Internet browser window that includes a library of custom pods. After selecting a custom pod, the custom pod is then available for use in the pod toolbar 602.

FIG. 6 also includes a cancel control 614 and a done control 616. The cancel control 614 may be used to exit the edit mode and cancel any changes made to the interface design. The done control 616 may be used to exit the edit mode and incorporate any changes made.

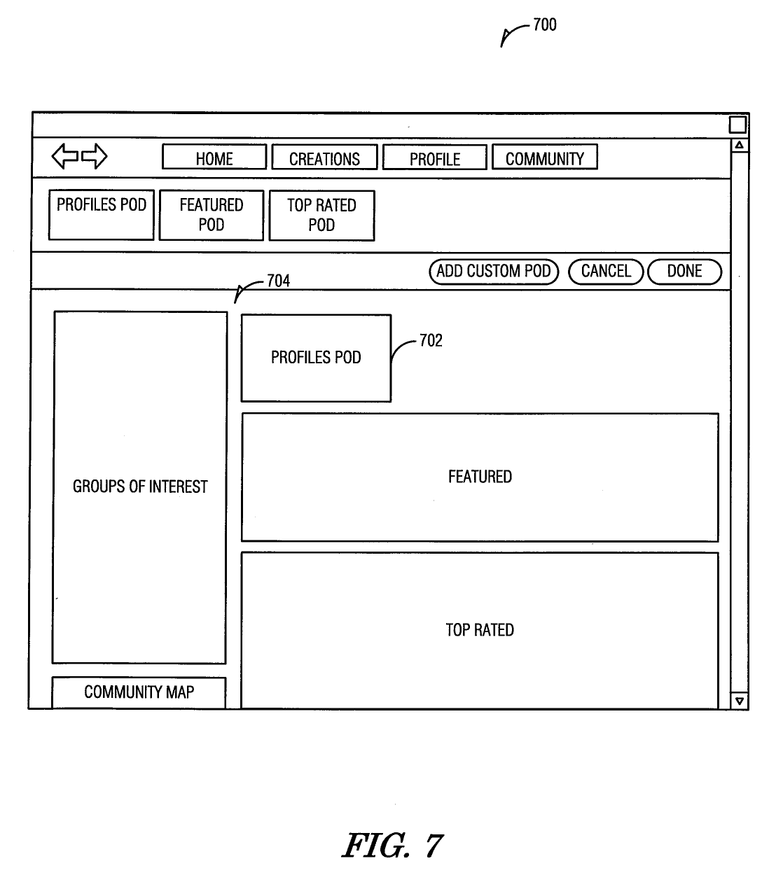

FIG. 7 is a diagram illustrating a graphical user interface 700, according to example embodiments. In FIG. 7, a profiles pod template 702 is illustrated as being placed in the staging area 704. When a pod template is placed in the staging area, other pods may automatically reposition to avoid collisions in the plane. Pods may be placed such that they overlap each other and then in presentation mode, the pods may be navigated similar to windows in a windowed user interface. The user may change the width and/or the height of a pod frame, for example, by click-dragging the corners or edges of the pod frame.

FIG. 8 is a diagram illustrating a graphical user interface 800, according to example embodiments. In the embodiment illustrated in FIG. 8, the profiles pod 802 is in a configuration mode. In particular, the profiles pod 802 includes a layout area 804 and a controls area 806. The layout area 804 can be used to arrange or resize the information that will be displayed in the profiles pod 802 when in presentation mode. The layout area 804 in this example includes a photo placeholder 808 and a name placeholder 810. The photo placeholder 808 corresponds with a photo control 812 and the name placeholder 810 corresponds with a profile name control 814. By checking or unchecking the checkbox controls in the controls area 806, a user can configure the profiles pod 802 to display selected information. In an example embodiment, when a user selects a particular checkbox control, an associated placeholder is displayed in the layout area 804. In addition, the controls area 804 includes a results displayed control 816, which may be used to set the number of results displayed in the profiles pod 802 when in presentation mode.

Other controls may be available to a user. The controls may be made available based on the type of pod being configured. Some examples of additional controls include sorting controls, font controls, color controls, or other pod behavior controls. Some examples of pod behavior that may be configurable include locking the pod's position, removing maximize, minimize, or close controls on a pod, or forcing a pod to always be on top of other pods in a tiled or windowed interface. Other aspects may be configurable based on the implementation of the pod.

While adding, removing, arranging, and configuring pods are described in the context of the edit mode in FIGS. 5-8, it is understood that some or all of these actions may be available in the presentation mode. For example, a user interface control, such as a contextual popup menu, may be accessed to change one or more pods from a presentation mode to a configuration mode, such as that illustrated in FIG. 8. Other contextual menus, controls, or keyboard actions may be used to perform the functions illustrated in FIGS. 6-8.

In some embodiments, pods may be related by one or more functional relationships. The functional relationships may be configurable, for example, using the configuration mode illustrated in FIG. 8. Examples of functional relationships include, but are not limited to, changing the contents of one pod when another pod's contents are changed; detecting a selection, activation, or focus of an element in one pod and changing, altering, replacing, or removing an element in another pod; or detecting a change in a document, file, or other asset contained in one pod and changing, altering, replacing, or removing an element in another pod.

### Example Logic

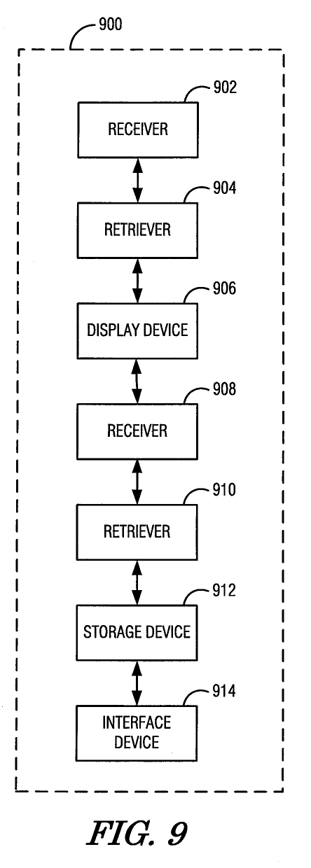

FIG. 9 is a block diagram of a computer system 900, according to an example embodiment, used to configure a user interface. The blocks illustrated herein may be implemented in hardware, firmware, software, or any combination thereof. These blocks may be implemented by the one or more machines (e.g., 108, 110, 112, 114, or 118) of the social networking system 102. In addition, some or all of the functionality of these blocks may be implemented at a client computer (e.g., 104). Further, these blocks are communicatively coupled via a logical or physical connection.

Illustrated is the computer system 900 including a receiver 902 to receive a first configuration for a first configurable software object, where the first configuration includes size and position data for displaying the first configurable software object in a display. Communicatively coupled to the receiver 902 is a retriever 904 to retrieve first data for the first configurable software object, the first data retrieved by a client-side engine associated with the display. Communicatively coupled to the retriever 904 is a display device 906 to display the first data in the display using the first configurable software object, where the first configurable software object is configured to display the data using the first configuration. Communicatively coupled to the display device 906 is additional receiver 908 to receive a second configuration of a second configurable software object, the second configurable software object to interact with the first configurable software object and the second configuration including size and position data for displaying the second configurable software object in the display. Communicatively coupled to the additional receiver 908 is an additional retriever 910 to retrieve second data for the second configurable software object, the second data retrieved by the client-side engine associated with the display. The display device 906 is further adapted to display the second data in the display using the second configurable software object, the second data displayed based on the interaction with the first configurable software object, and where the second configurable software object is configured to display the second data using the second configuration. In an example embodiment, the display device displays the first configurable software object as a first sub-display within the display and the second configurable software object as a second sub-display within the display. Communicatively coupled to the additional retriever 910 is a storage device 912 to store the configuration at a social networking system. Communicatively coupled to the storage device 912 is an interface device 914 to access a software object library to retrieve the first configurable software object. The interface device 914 may be adapted to access an electronic document using the first configured software object and the display device 906 may be adapted to display the electronic document using the first configurable software object, in an example embodiment. The interface device 914 may be adapted to access a remote database managed by a social networking system and the retriever 904 may be adapted to retrieve a user-defined configuration, in an example embodiment.

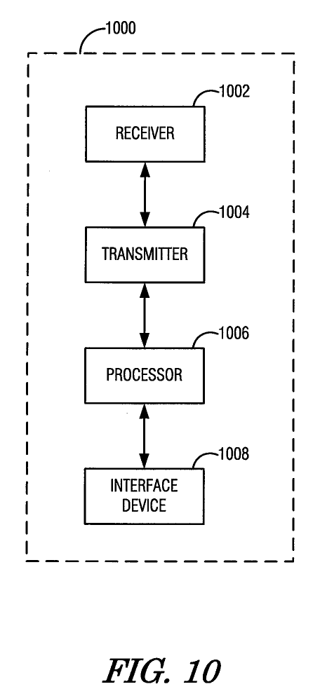

FIG. 10 is a block diagram of a computer system 1000, according to an example embodiment, used to provide a configurable software object. The blocks illustrated herein may be implemented in hardware, firmware, software, or any combination thereof. These blocks may be implemented by the one or more machines (e.g., 108, 110, 112, 114, or 118) of the social networking system 102. In addition, some or all of the functionality of these blocks may be implemented at a client computer (e.g., 104). Further, these blocks are communicatively coupled via a logical or physical connection.

Illustrated is the computer system 1000 including a receiver 1002 to receive a request for a configurable software object, the configurable software object including size and position data for use in a display. In an example embodiment, the configuration for a particular configurable software object is stored within the object itself. In another example embodiment, the configuration is stored separate from the software object, for example, at a social networking server. Communicatively coupled to the receiver 1002 is a transmitter 1004 to transmit the configurable software object to a client, the client adapted to display the configurable software object using the using size and position data. Communicatively coupled to the transmitter 1004 is a processor 1006 to determine whether the configurable software object has an associated user-defined configuration. Communicatively coupled to the processor 1006 is an interface device 1008 to access the user-defined configuration when the user-defined configuration exists. In an example embodiment, the interface device 1008 is further adapted to query a database associated with a social networking system to obtain the user-defined configuration. In an example embodiment, the interface device 1008 is adapted to access a software object library to retrieve the requested configurable software object. The request may include viewport dimensions of a display device to be used to present the configurable software object. In an example embodiment, the processor 1006 is adapted to revise the configuration associated with the configurable software object to conform to the viewport dimensions.

### Hardware Platform

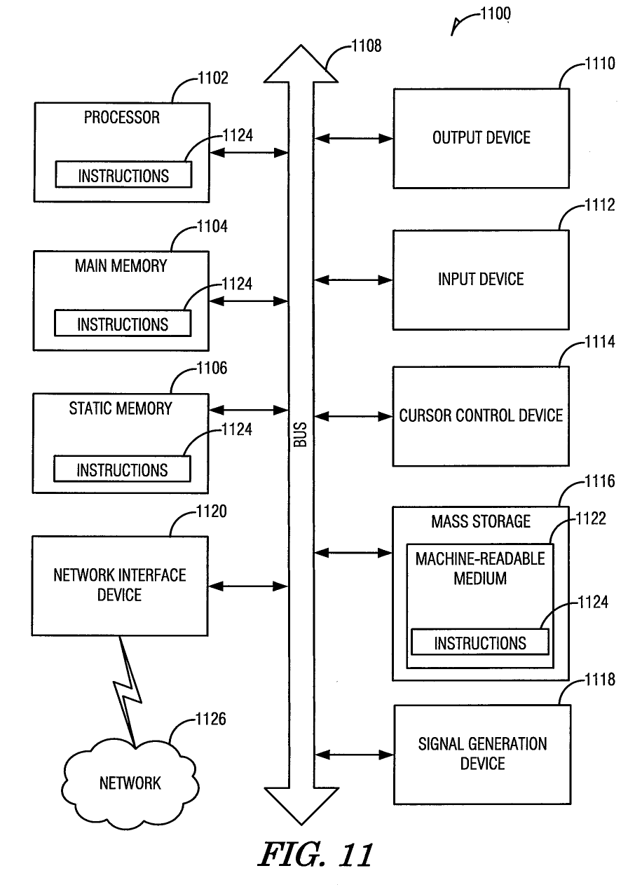

FIG. 11 is a block diagram of an article of manufacture, including a machine 1100, according to various embodiments. Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment.

Thus, other embodiments may be realized. For example, an article of manufacture, such as a computer, a memory system, a magnetic or optical disk, some other storage device, and/or any type of electronic device or system may include one or more processors 1102 coupled to a machine-readable medium 1122 such as a memory (e.g., removable storage media, as well as any memory including an electrical, optical, or electromagnetic conductor) having instructions 1124 stored thereon (e.g., computer program instructions), which when executed by the one or more processors 1102 result in performing any of the actions described with respect to the methods above.

Machine 1100 may take the form of a computer system having the processor 1102 coupled to a number of components directly, and/or using a bus 1108. Such components may include main memory 1104, static or non-volatile memory 1106, and mass storage 1116. Other components coupled to the processor 1102 may include an output device 1110, such as a video display, an input device 1112, such as a keyboard, and a cursor control device 1114, such as a mouse. A network interface device 1120 to couple the processor 1102 and other components to a network 1126 may also be coupled to the bus 1108. The instructions 1124 may further be transmitted or received over the network 1126 via the network interface device 1120 utilizing any one of a number of well-known transfer protocols (e.g., HTTP). A signal generation device 1118 is also coupled to the bus 1108, where the signal generation device 1118 may be used to generate a signal for the machine 1100. This signal may use the 802.11 family of protocols. Any of these elements coupled to the bus 1108 may be absent, present singly, or present in plural numbers, depending on the specific embodiment to be realized.

The processor 1102, the memories 1104, 1106, and the storage device 1120 may each include instructions 1124 which, when executed, cause the machine 1100 to perform any one or more of the methods described herein. In alternative embodiments, the machine 1100 operates as a standalone device or may be connected (e.g., networked) to other machines. In a networked environment, the machine 1100 may operate in the capacity of a server or a client machine in server-client network environment, or as a peer machine in a peer-to-peer (or distributed) network environment. The machine 1100 may be a Personal Computer (PC), a tablet PC, a Set-Top Box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine 1100 is illustrated, the term “machine” shall also be taken to include any collection of machines that individually or jointly execute a set (or multiple sets) of instructions to perform any one or more of the methodologies discussed herein.

While the machine-readable medium 1122 is shown as a single medium, the term “machine-readable medium” should be taken to include a single medium or multiple media (e.g., a centralized or distributed database, and/or associated caches and servers, and or a variety of storage media, such as the processor 1102 registers, memories 1104, 1106, and the storage device) that store the one or more sets of instructions 1124. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to tangible media, such as solid-state memories and optical and magnetic media, and intangible media, such as carrier wave signals.

### Conclusion

Implementing the apparatus, systems, and methods of the various embodiments may provide the ability to configure a user interface for an online community. Although embodiments of the invention have been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those of ordinary skill in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Embodiments may, for example, be implemented as a stand-alone application (e.g., without any network capabilities), a client-server application or a peer-to-peer (or distributed) application. Embodiments may also, for example, be deployed by Software-as-a-Service (SaaS), Application Service Provider (ASP), or utility computing providers, in addition to being sold or licensed via traditional channels.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of ordinary skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
receiving a first configuration for a first configurable software object, the first configuration including display control data for displaying the first configurable software object in a display;
retrieving first data for the first configurable software object, the first data retrieved by a client-side engine associated with the display;
displaying the first data in the display using the first configurable software object, wherein the first configurable software object is configured to display the first data using the first configuration;
receiving a second configuration of a second configurable software object, the second configuration including display control data for displaying the second configurable software object in the display based on interaction of the second configurable software object with the first configurable software object;
retrieving second data for the second configurable software object, the second data retrieved by the client-side engine associated with the display; and
displaying the second data in the display using the second configurable software object, the second configurable software object configured to display the second data using the second configuration based on the interaction of the second configurable software object with the first configurable software object.

2. (canceled)

3. The computer-implemented method of claim 1, wherein the first configurable software object is displayed as a first sub-display within the display, and the second configurable software object is displayed as a second sub-display within the display at a same time as the first sub-display.

4. The computer-implemented method of claim 1, further comprising:
storing the first configuration within a social networking system.

5. The computer-implemented method of claim 1, further comprising:
accessing a software object library to retrieve the first configurable software object.

6. The computer-implemented method of claim 1, further comprising:
accessing an electronic document using the first configurable software object; and
displaying the electronic document using the first configurable software object.

7. The computer-implemented method of claim 1, wherein the first configuration is user-defined.

8. The computer-implemented method of claim 7, wherein receiving the first configuration further comprises:
accessing a remote database managed by a social networking system; and
retrieving a user-defined configuration.

9. A computer-implemented method comprising:
receiving a request for a configurable software object, the configurable software object associated with a configuration comprising display control data for use in a display, the request comprising viewport dimensions of the display to be used to present the configurable software object;
revising the display control data of the configuration associated with the configurable software object to conform to the viewport dimensions; and
transmitting the configurable software object to a client, the client adapted to display the configurable software object using the display control data.

10. The computer-implemented method of claim 9, further comprising:
determining whether the configurable software object has an associated user-defined configuration; and
accessing the user-defined configuration for use as the configuration associated with the configurable software object when the user-defined configuration exists.

11. The computer-implemented method of claim 10, wherein accessing the user-defined configuration further comprises:
querying a database associated with a social networking system to obtain the user-defined configuration.

12. The computer-implemented method of claim 9, further comprising:
accessing a software object library to retrieve the requested configurable software object.

13. (canceled)

14. A computer system comprising:
a receiver to receive a first configuration for a first configurable software object, the first configuration including display control data for displaying the first configurable software object in a display;
a retriever to retrieve first data for the first configurable software object, the first data retrieved by a client-side engine associated with the display;
a display device to display the first data in the display using the first configurable software object, wherein the first configurable software object is configured to display the first data using the first configuration;
the receiver to receive a second configuration of a second configurable software object, the second configuration including display control data for displaying the second configurable software object in the display based on interaction of the second configurable software object with the first configurable software object;
the retriever to retrieve second data for the second configurable software object, the second data retrieved by the client-side engine associated with the display; and
the display device to display the second data in the display using the second configurable software object, the second configurable software object configured to display the second data using the second configuration based on the interaction of the second configurable software object with the first configurable software object.

15. (canceled)

16. The computer system of claim 14, wherein the display device displays the first configurable software object as a first sub-display within the display and the second configurable software object as a second sub-display within the display at a same time as the first sub-display.

17. The computer system of claim 14, further comprising:
a storage device to facilitate the storage of the first configuration within a social networking system.

18. The computer system of claim 14, further comprising:
an interface device to access a software object library to retrieve the first configurable software object.

19. The computer system of claim 14, further comprising:
an interface device to access an electronic document using the first configurable software object; and
the display device to display the electronic document using the first configurable software object.

20. The computer system of claim 14, wherein the first configuration is user- defined.

21. The computer system of claim 20, wherein receiving the first configuration further comprises:
an interface device to access a remote database managed by a social networking system;
and the retriever to retrieve a user-defined configuration.

22. A computer system comprising:
a receiver to receive a request for a configurable software object, the configurable software object associated with a configuration comprising display control data for use in a display, the request comprising viewport dimensions of the display to be used to present the configurable software object;
at least one processor to revise the display control data of the configuration associated with the configurable software object to conform to the viewport dimensions; and
a transmitter to transmit the configurable software object to a client, the client adapted to display the configurable software object using the display control data.

23. The computer system of claim 22, further comprising:
a processor to determine whether the configurable software object has an associated user- defined configuration; and
an interface device to access the user-defined configuration for use as the configuration when the user-defined configuration exists.

24. The computer system of claim 23, wherein the interface device is further adapted to query a database associated with a social networking system to obtain the user- defined configuration.

25. The computer system of claim 22, further comprising:
an interface device to access a software object library to retrieve the requested configurable software object.

26. (canceled)

27. An apparatus comprising:
means for receiving a first configuration for a first configurable software object, the first configuration including display control data for displaying the first configurable software object in a display;
means for retrieving first data for the first configurable software object, the first data retrieved by a client-side engine associated with the display;
means for displaying the first data in the display using the first configurable software object, wherein the first configurable software object is configured to display the first data using the first configuration;
the receiving means receiving a second configuration of a second configurable software object, the second configuration including display control data for displaying the second configurable software object in the display based on interaction of the second configurable software object with the first configurable software object;
the retrieving means retrieving second data for the second configurable software object, the second data retrieved by the client-side engine associated with the display; and
the displaying means displaying the second data in the display using the second configurable software object, the second configurable software object configured to display the second data using the second configuration based on the interaction of the second configurable software object with the first configurable software object.

28. A machine-readable storage device comprising instructions, which when implemented by one or more machines, cause the one or more machines to:
receive a first configuration for a first configurable software object, the first configuration including display control data for displaying the first configurable software object in a display;
retrieve first data for the first configurable software object, the first data retrieved by a client-side engine associated with the display;
display the first data in the display using the first configurable software object, wherein the first configurable software object is configured to display the first data using the first configuration;
receive a second configuration of a second configurable software object, the second configuration including display control data for displaying the second configurable software object in the display based on interaction of the second configurable software object with the first configurable software object;
retrieve second data for the second configurable software object, the second data retrieved by the client-side engine associated with the display; and
display the second data in the display using the second configurable software object, the second configurable software object configured to display the second data using the second configuration based on the interaction of the second configurable software object with the first configurable software object.

29. The computer-implemented method of claim 1, wherein the interaction of the second configurable software object with the first configurable software object comprises changing contents of the second configurable software object in response to a change of contents of the first configurable software object.

30. The computer-implemented method of claim 1, wherein the interaction of the second configurable software object with the first configurable software object comprises changing, altering, replacing, or removing an element of the second configurable software object in response to detecting a selection, activation, or focus of an element of the first configurable software object.

31. The computer-implemented method of claim 1, wherein the interaction of the second configurable software object with the first configurable software object comprises changing, altering, replacing, or removing an element of the second configurable software object in response to detecting a change in an asset included in the first configurable software object.
